(19) United States
(12) Patent Application Publication
(10) Pub. No.: US 2025/0167351 A1
(43) Pub. Date: May 22, 2025

(54) LAMINATED BATTERY

(71) Applicant: TOYOTA JIDOSHA KABUSHIKI KAISHA, Toyota-shi (JP)

(72) Inventors: Yusuke IKEDA, Miyoshi-shi (JP); Kenichi KAKISHITA, Nagoya-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/935,682

(22) Filed: Nov. 4, 2024

(30) Foreign Application Priority Data
Nov. 17, 2023 (JP) 2023-196136

(51) Int. Cl. H01M 50/112; B60L 50/64; H01M 50/147; H01M 50/15; H01M 50/164

(52) U.S. Cl. CPC H01M 50/112; H01M 50/147; H01M 50/15; H01M 50/164; B60L 50/64; H01M 2220/20

(57) ABSTRACT

A laminated battery includes an electrode stack including a plurality of electrodes stacked together and having a cuboid shape, and a laminate film covering and sealing the electrodes. The laminate film includes a film body covering four surfaces of the electrode stack, a film partitioning wall interposed between two adjacent electrodes of the plurality of electrodes, and cover members that are twice as many as the electrodes. The film body and the film partitioning wall define accommodating portions respectively accommodating the electrodes. The cover members cover two remaining uncovered sides of each accommodating portion. The cover members each have a recess-shaped portion including a bottom wall and four side walls. An outer surface or an inner surface of the bottom wall faces a side surface of a corresponding one of the electrodes. Outer surfaces of the side walls are fusion-bonded to the film body or the film partitioning wall.

### CROSS-REFERENCE TO RELATED APPLICATION

This application claims priority to Japanese Patent Application No. 2023-196136 filed on Nov. 17, 2023, incorporated herein by reference in its entirety.

### BACKGROUND

### 1. Technical Field

The present disclosure relates to a laminated battery.

### 2. Description of Related Art

A laminated battery in which an electrode including a positive electrode, a negative electrode, and a separator is covered and sealed by a laminate film has been studied.

For example, Japanese Unexamined Patent Application Publication No. 2013-058498 (JP 2013-058498 A) discloses a battery pack of an assembled battery including a plurality of cells each hermetically sealed by a laminate film, a case storing the cells that are stacked together, a positive electrode terminal and a negative electrode terminal of the assembled battery, a cover member, and fixing means. The positive electrode terminal and the negative electrode terminal of the assembled battery, in which the cells are connected in parallel or series, are connected to an apparatus outside the case. The cover member presses the uppermost surface of the stacked cells stored in the case in a direction opposed to the stacking direction of the cells toward the inside of the case. The fixing means fixes the cover member to the case, at a position where a predetermined pressing force is applied.

### SUMMARY

In order to achieve, for example, downsizing of a product equipped with a battery, downsizing of the battery itself has been required. For this reason, even in a battery in which an electrode stack including a plurality of electrodes stacked together is covered by a laminate film, it is desired that the entire size of the battery after the electrode stack is sealed by the laminate film be reduced by minimizing the volume of, for example, a space generated by the presence of the laminate film.

The present disclosure has been made in view of the above circumstances, and an object of the present disclosure is to provide a laminated battery having high volumetric efficiency.

Means for solving the above-described problem includes the following aspects.

(1) A laminated battery includes: an electrode stack including a plurality of electrodes stacked together and having a cuboid shape; and a laminate film covering and sealing the electrodes of the electrode stack. The laminate film includes: a film body covering four surfaces of the electrode stack; a film partitioning wall interposed between two adjacent electrodes of the plurality of electrodes of the electrode stack; and cover members that are twice as many as the electrodes. The film body and the film partitioning wall define accommodating portions each accommodating a corresponding one of the electrodes. The cover members cover two sides of each of the accommodating portions. The two sides are not covered by either the film body or the film partitioning wall. Each of the cover members has a recess-shaped portion that includes a bottom wall and four side walls. An outer surface or an inner surface of the bottom wall of the recess-shaped portion of each of the cover members faces a side surface of a corresponding one of the electrodes. Outer surfaces of the side walls of the recess-shaped portion are fusion-bonded to the film body or the film partitioning wall.

(2) In the laminated battery according to the aspect (1), the outer surface of the bottom wall of the recess-shaped portion of each of the cover members faces the side surface of the corresponding one of the electrodes.

(3) In the laminated battery according to the aspect (2), fusion-bonded portions where the outer surfaces of the side walls of the recess-shaped portion of each of the cover members are fusion-bonded to the film body or the film partitioning wall are folded inward in the recess-shaped portion.

According to the present disclosure, a laminated battery having high volumetric efficiency is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view illustrating a laminate film of a laminated battery according to a first embodiment of the present disclosure;

FIG. 1B is a schematic perspective view illustrating a laminate film of a laminated battery according to a second embodiment of the present disclosure;

FIG. 2 is a schematic side view illustrating a modification of the laminated battery according to the first embodiment of the present disclosure;

FIG. 3 is a schematic plan view illustrating main parts of a vehicle;

FIG. 4 is a schematic perspective view illustrating a battery module;

FIG. 5 is a plan view illustrating the battery module with a top cover thereof removed; and

FIG. 6 is a schematic view illustrating a battery cell accommodated in the battery module, as viewed in the thickness direction of the battery cell.

### DETAILED DESCRIPTION OF EMBODIMENTS

The following will describe embodiments as examples according to the present disclosure. The descriptions and examples are illustrative of the embodiments and are not intended to limit the scope of the disclosure. Regarding numerical ranges in phases described in this specification, an upper limit or a lower limit of one numerical range described in one phase may be replaced with an upper limit or a lower limit of another numerical range described in another phase. Further, regarding the numerical ranges described in this specification, an upper limit or a lower limit of a numerical range may be replaced with a value indicated in the embodiments.

### Laminated Battery

A laminated battery according to the embodiment of the present disclosure includes: an electrode stack including a plurality of electrodes stacked together and having a cuboid shape; and a laminate film covering and sealing the electrodes of the electrode stack. The laminate film includes: a film body covering four surfaces of the electrode stack; a film partitioning wall interposed between two adjacent electrodes of the plurality of electrodes of the electrode stack; and cover members that are twice as many as the electrodes. The film body and the film partitioning wall define accommodating portions each accommodating a corresponding one of the electrodes. The cover members cover two sides of each of the accommodating portions. The two sides are not covered by either the film body or the film partitioning wall. Each of the cover members has a recess-shaped portion that includes a bottom wall and four side walls. An outer surface or an inner surface of the bottom wall of the recess-shaped portion of each of the cover members faces a side surface of a corresponding one of the electrodes. Outer surfaces of the side walls of the recess-shaped portion are fusion-bonded to the film body or the film partitioning wall.

In order to achieve, for example, downsizing of a product equipped with a battery, downsizing of the battery itself has been required. For this reason, even in a battery in which an electrode stack including a plurality of electrodes stacked together is covered by a laminate film, it is required that the volume of, for example, a space generated by covering the electrode stack by the laminate film be reduced. In other words, reduction of the entire size of the battery including the laminate film is desired. A conventional laminated battery has a configuration in which, for example, each of electrodes of an electrode stack is covered by a single sheet of laminate film, and the electrodes each of which is covered by a single sheet of laminate film are stacked together. In this case, each of the electrodes is sealed by a single sheet of laminate film in the following manner: a single sheet of laminate film covers and wraps four surfaces of the corresponding electrode and both wrapping ends of the single sheet of laminate film are fusion-bonded to each other, and then excess portions of the laminate film on two side surfaces of the corresponding electrode that remain uncovered are enfolded inside and fusion-bonded.

On the other hand, the laminated battery according to the embodiments of the present disclosure has a configuration in which the film body covers the four surfaces of the electrode stack, the film partitioning wall is interposed between two adjacent electrodes of the plurality of electrodes of the electrode stack, and paired cover members, which are different members from the film body and the film partitioning wall, respectively cover the two sides (paired sides) of each of the accommodating portions defined by the film body and the film partitioning wall. One electrode is accommodated in each of the accommodating portions. The cover members are twice as many as the electrodes. The two sides are not covered by either the film body or the film partitioning wall. Therefore, in the configuration of the embodiments of the present disclosure, excess portions of the laminate film on the side surfaces of each of the electrodes of the electrode stack need not be enfolded inside and fusion-bonded. This configuration reduces the entire length of the laminated battery in the width direction thereof (the direction in which the two side surfaces of each of the electrodes face each other). Thus, the size of the laminated battery can be reduced. In addition, the number of sheets of laminate film interposed between the electrodes that are stacked together in this configuration is less than that in the conventional configuration in which each of the electrodes is individually sealed by the laminate film, that is, each of the electrodes of the electrode stack is individually covered by the laminate film and then the electrodes each covered by the laminate film are stacked together. In this respect as well, the size of the laminated battery can be reduced. As a result, the volumetric efficiency is improved, and thus the energy density is increased.

The following will now describe the laminated battery according to the embodiments of the present disclosure in detail with specific examples, with reference to the accompanying drawings. The drawings referred to in the following description are only schematically illustrated, and the sizes and shapes of components in the drawings are exaggerated as needed for easy understanding.

### First Embodiment

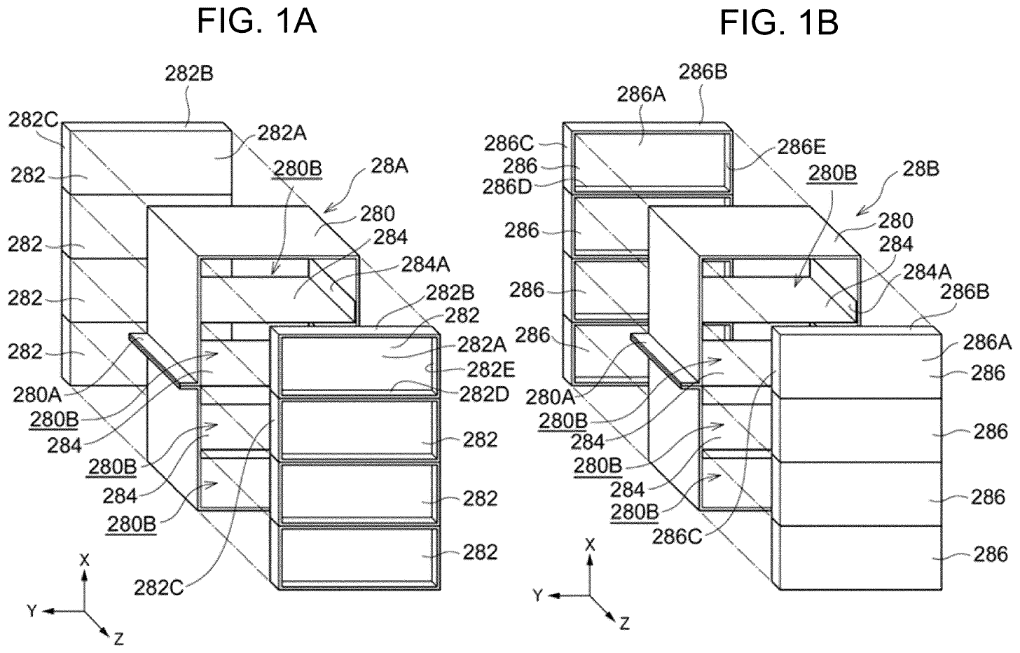

FIG. 1A is a schematic perspective view illustrating a laminate film of a laminated battery according to a first embodiment of the present disclosure. It is noted that, in FIG. 1A, illustration of an electrode stack including electrodes that are stacked together is omitted, and only the laminate film (a film body, film partitioning walls, and cover members) covering and sealing the electrode stack is illustrated, to facilitate the understanding of a configuration of the laminate film that is a feature of the present disclosure. FIG. 1A 25 illustrates the laminate film that seals the electrode stack including four electrodes that are stacked together.

A laminate film 28A illustrated in FIG. 1A includes a film body 280, three film partitioning walls 284, and eight cover members 282. In the laminate film 28A illustrated in FIG. 1A, four accommodating portions 280B are defined by the film body 280 and the three film partitioning walls 284. As indicated with dashed-dotted lines in FIG. 1A, the eight cover members 282 are fitted into the insides of the accommodating portions 280B that are defined by the film body 280 and the film partitioning walls 284. That is, one cover member 282 is fitted into each of the two sides of one accommodating portion 280B, so that each of the accommodating portions 280B is sealed. Then, in each of the four accommodating portions 280B, one electrode (not illustrated) is accommodated.

The film body 280 is composed of a single sheet of film. The film body 280 is disposed to cover the four surfaces of the electrode stack (the electrode stack including the four electrodes that are stacked together in FIG. 1A), and both ends of the film body 280 covering the electrode stack are fusion-bonded to each other, whereby a body fusion-bonded portion 280A is provided.

It is noted that the film body 280 illustrated in FIG. 1A is composed of a single sheet of film, but the film body 280 may be composed of two or more sheets of film. For example, the film body may be composed of two sheets of film and have two body fusion-bonded portions provided by fusion-bonding one end of a first sheet of film to one end of a second sheet of film and fusion-bonding the other end of the first sheet of film to the other end of the second sheet of film such that the film body is disposed to cover the four surfaces of the electrode stack.

An inner space of the film body 280 is partitioned with the three film partitioning walls 284 into four spaces, and the four spaces respectively provide the accommodating portions 280B. That is, in the laminate film 28A illustrated in FIG. 1A, each of the three film partitioning walls 284 is interposed between any two adjacent electrodes among the four electrodes of the electrode stack (not illustrated). Each of the film partitioning walls 284 is fusion-bonded and fixed to the film body 280 at a pair of partitioning-wall fusion-bonded portions 284A. In a state where the electrode stack including the four electrodes (not illustrated) is covered only by the film body 280 and the three film partitioning walls 284, two side surfaces (paired side surfaces) of each of electrodes are exposed.

The laminate film 28A includes the eight cover members 282. That is, the cover members 282 are twice as many as the electrodes. Each of the cover members 282 has a recessed shape defined by a bottom wall 282A and four side walls 282B, 282C, 282D, 282E. That is, each of the cover members 282 has a recess-shaped portion that includes the bottom wall 282A and the four side walls 282B, 282C, 282D, 282E. The cover members 282 are respectively fitted into the insides of the accommodating portions 280B defined by the film body 280 and the film partitioning walls 284 such that outer surfaces of the bottom walls 282A of the recess-shaped portions face the side surfaces of the electrodes (so as to face the accommodating portions 280B). As a result, the two side surfaces of each of the electrodes, which have not been covered by any of the film body 280 and the film partitioning walls 284, are covered by the bottom walls 282A of the cover members 282 (more specifically, the outer surfaces of the bottom walls 282A of the recess-shaped portions).

In addition, outer surfaces of the four side walls 282B, 282C, 282D, 282E of the recess-shaped portion of each of the cover members 282 fitted into the insides of the accommodating portions 280B are in contact with the film body 280 or the film partitioning walls 284. The outer surfaces of the four side walls 282B, 282C, 282D, 282E of each recess-shaped portion are fusion-bonded to the film body 280 or the film partitioning walls 284 in contact with the outer surfaces, whereby cover fusion-bonded portions are provided. As a result, the four electrodes of the electrode stack (not illustrated) are respectively sealed in the individual spaces (i.e., the four accommodating portions 280B) inside the laminate film 28A.

In the laminated battery with this configuration in which the electrode stack including the four electrodes that are stacked together is sealed by the laminate film 28A illustrated in FIG. 1A, the entire length of the laminated battery in the width direction thereof is reduced. With this configuration, the number of the sheets of laminate film interposed between the electrodes that are stacked together is also reduced. As a result, the size of the laminated battery is reduced, the volumetric efficiency is improved, and the energy density is increased.

### Modification of First Embodiment

In the laminated battery according to the first embodiment of the present disclosure, the fusion-bonded portions (i.e., the cover fusion-bonded portions) provided by fusion-bonding the outer surfaces of the side walls of the recess-shaped portions of the cover members to the film body or the film partitioning walls are preferably folded inward in the recess-shaped portions of the cover members.

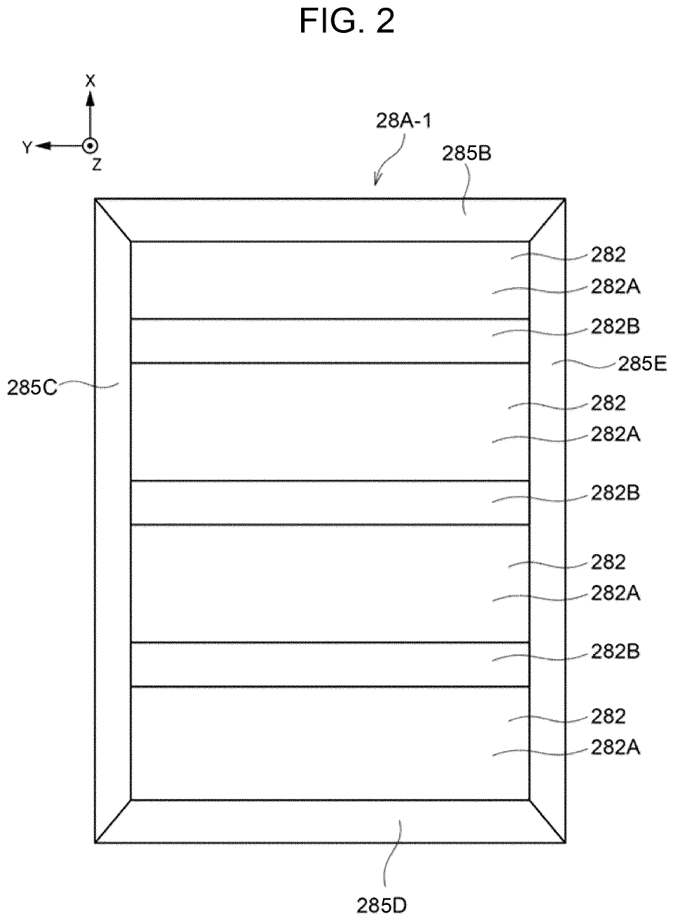

FIG. 2 is a schematic side view illustrating a modification of the laminated battery according to the first embodiment of the present disclosure. FIG. 2 is the side view of the laminated battery, as viewed in the width direction thereof (the direction in which the two side surfaces of each of the electrodes face each other, a Z-direction of FIG. 2).

The laminated battery illustrated in FIG. 2 is the laminated battery of FIG. 1A in which the electrode stack including the four electrodes that are stacked together is sealed by the laminate film 28A in a state where the fusion-bonded portions (i.e., the cover fusion-bonded portions), which are provided by fusion-bonding the outer surfaces of the four side walls 282B, 282C, 282D, 282E of the recess-shaped portion of each of the cover members 282 to the film body 280 or the film partitioning walls 284, are folded inward in the recess-shaped portions of the cover members 282.

In a laminate film 28A-1 illustrated in FIG. 2, the cover members 282 are fitted into the insides of the accommodating portions 280B defined by the film body 280 and the film partitioning walls 284. Then, the outer surfaces of the four side walls 282B, 282C, 282D, 282E of each of the cover members 282 are fusion-bonded to the film body 280 or the film partitioning walls 284, whereby cover fusion-bonded portions 285B, 285C, 285D, 285E are provided. Then, each of the cover fusion-bonded portions 285B, 285C, 285D, 285E is folded inward in the recess-shaped portions of the cover members 282. In the modification illustrated in FIG. 2, the cover fusion-bonded portions 285B, 285D are first folded inward in the recess-shaped portions of the cover members 282, and the cover fusion-bonded portions 285C, 285E are then folded inward in the recess-shaped portions of the cover members 282 such that the cover fusion-bonded portions 285B, 285D are partially covered from the outside by the cover fusion-bonded portions 285C, 285E.

Since the fusion-bonded portions provided by fusion-bonding the outer surfaces of the side walls of the recess-shaped portion of each of the cover members to the film body or the film partitioning walls are folded inward in the recess-shaped portions of the cover members, the entire length of the laminated battery in the width direction thereof (the direction in which the two side surfaces of each of the electrodes face each other, the Z-direction of FIG. 2) is further reduced. As a result, the size of the laminated battery is reduced, the volumetric efficiency is improved, and the energy density is increased.

### Second Embodiment

FIG. 1B is a schematic perspective view illustrating a laminate film of a laminated battery according to a second embodiment of the present disclosure. It is noted that, in FIG. 1B, the illustration of the electrode stack including the electrodes that are stacked together is omitted, and only the laminate film (the film body, the film partitioning walls, and the cover members) covering and sealing the electrode stack is illustrated, to facilitate the understanding of a configuration of the laminate film that is the feature of the present disclosure. FIG. 1B illustrates the laminate film that seals the electrode stack including the four electrodes that are stacked together.

A laminate film 28B illustrated in FIG. 1B includes the film body 280, the three film partitioning walls 284, and eight cover members 286. In the laminate film 28B illustrated in FIG. 1B, the four accommodating portions 280B are defined by the film body 280 and the three film partitioning walls 284. As indicated with dashed-dotted lines in FIG. 1B, the eight cover members 286 are fitted into the insides of the accommodating portions 280B that are defined by the film body 280 and the film partitioning walls 284. That is, one cover member 286 is fitted into each of the two sides of one accommodating portion 280B, so that each of the accommodating portions 280B is sealed. Then, in each of the four accommodating portions 280B, one electrode (not illustrated) is accommodated.

The film body 280 and the film partitioning walls 284 have the same configurations as those illustrated in FIG. 1A, and thus the description about these configurations will be omitted below.

The laminate film 28B includes the eight cover members 286. That is, the cover members 286 are twice as many as the electrodes. Each of the cover members 286 has a recess-shape defined by a bottom wall 286A and four side walls 286B, 286C, 286D, 286E. That is, each of the cover members 286 has a recess-shaped portion that includes the bottom wall 286A and the four side walls 286B, 286C, 286D, 286E. The cover members 286 are respectively fitted into the insides of the accommodating portions 280B defined by the film body 280 and the film partitioning walls 284 such that inner surfaces of the bottom walls 286A of the recess-shaped portions face side surfaces of the electrodes (so as to face the accommodating portions 280B). As a result, the two side surfaces of each of the electrodes, which have not been covered by any of the film body 280 and the film partitioning walls 284, are covered by the bottom walls 286A of the cover members 286 (more specifically, the inner surfaces of the bottom walls 286A of the recess-shaped portions).

In addition, outer surfaces of the four side walls 286B, 286C, 286D, 286E of the recess-shaped portion of each of the cover members 286 fitted into the insides of the accommodating portions 280B are in contact with the film body 280 or the film partitioning walls 284. The outer surfaces of the four side walls 286B, 286C, 286D, 286E of each recess-shaped portion are fusion-bonded to the film body 280 or the film partitioning walls 284 in contact with the outer surfaces, whereby the cover fusion-bonded portions are provided. As a result, the four electrodes of the electrode stack (not illustrated) are respectively sealed in the individual spaces (i.e., the four accommodating portions 280B) inside the laminate film 28B.

In the laminated battery with this configuration in which the electrode stack including the four electrodes that are stacked together is sealed by the laminate film 28B illustrated in FIG. 1B, the entire length of the laminated battery in the width direction thereof is reduced. With this configuration, the number of the sheets of laminate film interposed between the electrodes that are stacked together is also reduced. As a result, the size of the laminated battery is reduced, the volumetric efficiency is improved, and the energy density is increased.

The following will now describe a battery module, a battery pack, and a vehicle, each including the laminated battery according to the above-described embodiments of the present disclosure, with reference to the accompanying drawings.

### Overall Configuration of Vehicle 100

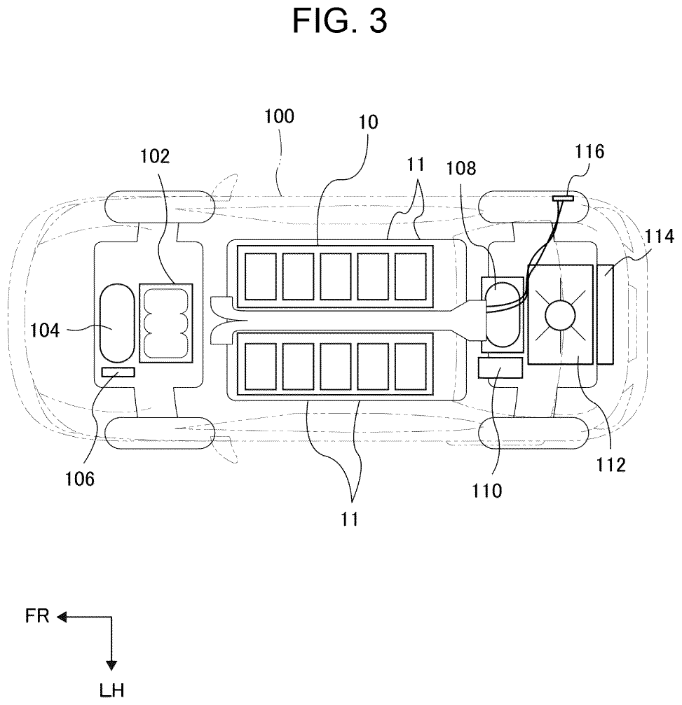

FIG. 3 is a schematic plan view illustrating main parts of a vehicle 100 to which a battery pack 10 according to a present embodiment is applied. As illustrated in FIG. 3, the vehicle 100 is a battery electric vehicle (BEV) equipped with the battery pack 10 under a vehicle floor. It is noted that, in the drawings, an arrow UP indicates an upward direction in the vehicle up-down direction, an arrow FR indicates a front side in the vehicle front-rear direction, and an arrow LH indicates a left side in the vehicle-width direction. In the following description of directions, “front” and “rear” refer to the front side and the rear side, respectively, in the vehicle front-rear direction, “right” and “left” refer to the right side and the left side, respectively, in the vehicle-width direction, and “upper” and “lower” refer to the upper side and the lower side, respectively, in the vehicle up-down direction, unless otherwise specified.

The vehicle 100 according to a present embodiment has, for example, a configuration in which a DC/DC converter 102, an electric compressor 104, and a positive temperature coefficient (PTC) heater 106 are disposed forward of the battery pack 10 in the vehicle front-rear direction. A motor 108, a gearbox 110, an inverter 112, and a charger 114 are disposed rearward of the battery pack 10 in the vehicle front-rear direction.

Direct current output from the battery pack 10 is supplied to the electric compressor 104, the PTC heater 106, the inverter 112, and others after a voltage of the direct current is regulated by the DC/DC converter 102. By supplying power to the motor 108 via the inverter 112, rear wheels of the vehicle rotate to cause the vehicle 100 to travel.

A charging port 116 is provided on the right side of a rear portion of the vehicle 100. By connecting a charging plug of external charging equipment (not illustrated) through the charging port 116 to the charger 114, power is stored in the battery pack 10 via the charger 114.

It is noted that arrangements and structures of components of the vehicle 100 are not limited to the above-described configuration. The battery pack 10 may be applied to, for example, a hybrid electric vehicle (HEV) equipped with an engine or a plug-in hybrid electric vehicle (PHEV) equipped with an engine. In the present embodiment, the vehicle is a rear-wheel-drive vehicle in which the motor 108 is disposed in a vehicle rear portion, but the configuration is not limited to that described above. The vehicle may be a front-wheel-drive vehicle in which the motor 108 is disposed in a vehicle front portion. Alternatively, the vehicle may be a vehicle including a pair of the motors 108, one of which is disposed in a vehicle front portion and the other of which is disposed in a vehicle rear portion. Alternatively, the vehicle may be a vehicle in which each of the wheels is provided with an in-wheel motor.

The battery pack 10 includes a plurality of the battery modules 11. The present embodiment indicates an example in which ten units of the battery modules 11 are provided. Specifically, five units of the battery modules 11 are arranged in the vehicle front-rear direction on the right side of the vehicle 100, and the remaining five units of the battery modules 11 are arranged in the vehicle front-rear direction on the left side of the vehicle 100. The battery modules 11 are electrically connected to each other.

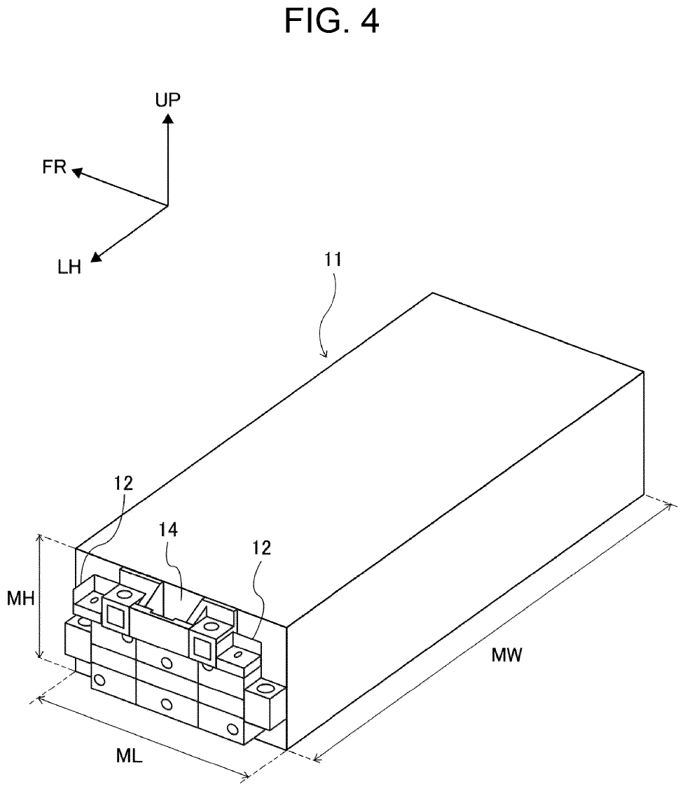

FIG. 4 is a schematic perspective view illustrating the battery module 11. As illustrated in FIG. 4, the battery module 11 has a substantially cuboid shape and is disposed with a longitudinal side thereof extending in the vehicle-width direction. A shell of the battery module 11 is made of an aluminum alloy. The shell of the battery module 11 is made by, for example, joining aluminum die-cast portions to both ends having an extruded profile of the aluminum alloy by laser welding.

A pair of voltage terminals 12 and a connector 14 are provided at each of both ends of the battery module 11 in the vehicle-width direction. A flexible printed circuit (FPC) 22, which will be described later, is connected to the connector 14. A busbar (not illustrated) is welded to each of both the ends of the battery module 11 in the vehicle-width direction.

A length MW of the battery module 11 in the vehicle-width direction is, for example, from 350 mm to 600 mm. A length ML of the battery module 11 in the vehicle front-rear direction is, for example, from 150 mm to 250 mm. A height MH of the battery module 11 in the vehicle up-down direction is, for example, from 80 mm to 110 mm.

FIG. 5 is a plan view illustrating the battery module 11 with a top cover thereof removed. As illustrated in FIG. 5, multiple battery cells 20 are arranged and accommodated inside the battery module 11. The present embodiment indicates an example in which 24 units of the battery cells 20 are arranged in the vehicle front-rear direction and bonded together.

The FPC 22 is disposed on the battery cells 20. The FPC 22 has a strip shape with a longitudinal side thereof extending in the vehicle-width direction. Each of both end portions of the FPC 22 is provided with a thermistor 24. The thermistors 24 are not bonded onto the battery cells 20, but the thermistors 24 are pressed toward the battery cells 20 by an upper cover of the battery module 11.

One or more shock absorbing materials (not illustrated) are accommodated inside the battery module 11. The shock absorbing material is, for example, an elastically deformable member having a thin plate shape, and is interposed between of the battery cells 20 that are adjacent to each other, with a thickness direction of the shock absorbing material extending in the arrangement direction of the battery cells 20. The present embodiment indicates an example in which the shock absorbing materials are disposed at both end portions of the battery module 11 in the longitudinal direction, and a center portion of the battery module 11 in the longitudinal direction.

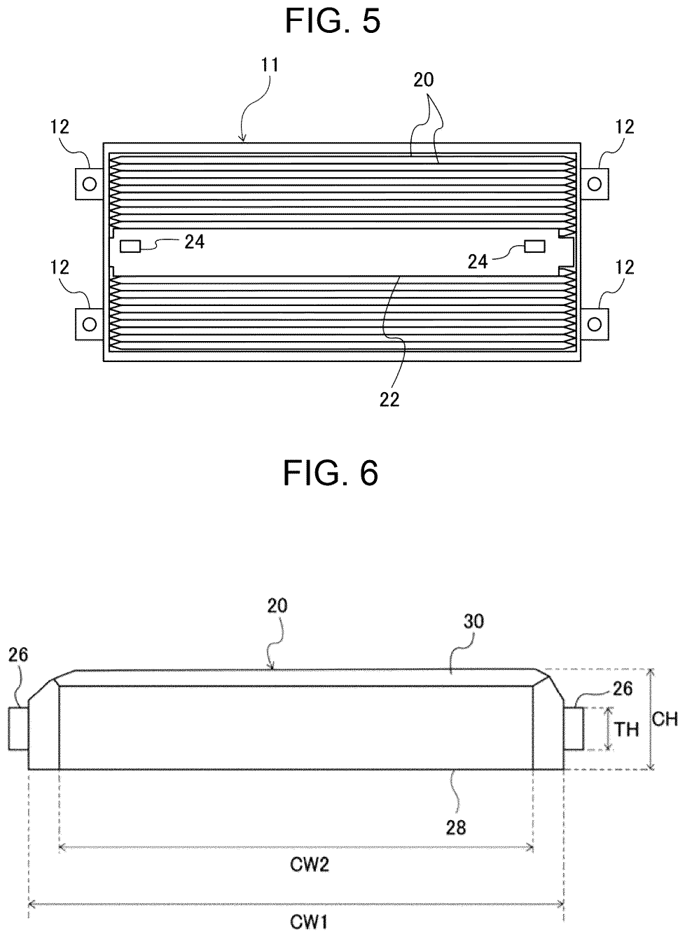

FIG. 6 is a schematic view illustrating the battery cell 20 that is accommodated in the battery module 11, as viewed in the thickness direction of the battery cell 20. As illustrated in FIG. 6, the battery cell 20 has a substantially rectangular plate shape, and an electrode (not illustrated) is accommodated inside the battery cell 20. The electrode includes a positive electrode, a negative electrode, and a separator that are stacked together, and is sealed by the laminate film 28.

The present embodiment indicates an example in which the laminate film 28 that is embossed and has a sheet shape is folded and pasted together to provide an accommodating portion for the electrode. Any of the following embossing structures may be employed: a single-cap embossing structure in which a laminate film is embossed at one location; and a double-cap embossing structure in which a laminate film is embossed at two locations. In the present embodiment, the single-cap embossing structure with a draw depth range from approximately 8 mm to approximately 10 mm is employed.

Both upper ends of the battery cell 20 in the longitudinal direction are bent, so that the outline shape thereof is provided with corners. An upper end portion of the battery cell 20 in the up-down direction is bent, and a fixing tape 30 wraps around and extends along the upper end portion of the battery cell 20 in the longitudinal direction.

Each of both ends of the battery cell 20 in the longitudinal direction is provided with a terminal (tab) 26. The present embodiment indicates an example in which each terminal 26 is disposed at a position below the center of the battery cell 20 in the up-down direction. Each terminal 26 is joined to a busbar (not illustrated) by laser welding or the like.

A length CW1 of the battery cell 20 in the vehicle-width direction is, for example, 530 mm to 600 mm, 600 mm to 700 mm, 700 mm to 800 mm, 800 to 900 mm, or 1000 mm or more. A length CW2 of an area in which the electrode is accommodated is, for example, 500 mm to 520 mm, 600 mm to 700 mm, 700 mm to 800 mm, 800 to 900 mm, or 1000 mm or more. A height CH of the battery cell 20 is, for example, 80 mm to 110 mm, or 110 mm to 140 mm. A thickness of the battery cell 20 is 5.0 mm to 7.0 mm, 7.0 mm to 9.0 mm, or 9.0 mm to 11.0 mm. A height TH of the terminal 26 is 40 mm to 50 mm, 50 mm to 60 mm, or 60 mm to 70 mm.

What is claimed is:

1. A laminated battery comprising:
an electrode stack including a plurality of electrodes stacked together, each of the electrodes having a cuboid shape; and
a laminate film covering and sealing the electrodes of the electrode stack,
wherein the laminate film includes
a film body covering four surfaces of the electrode stack,
a film partitioning wall interposed between two adjacent electrodes of the plurality of electrodes of the electrode stack, the film body and the film partitioning wall defining accommodating portions each accommodating a corresponding one of the electrodes, and
cover members that are twice as many as the electrodes, the cover members covering two sides of each of the accommodating portions, and the two sides being not covered by either the film body or the film partitioning wall, and
wherein each of the cover members has a recess-shaped portion that includes a bottom wall and four side walls, an outer surface or an inner surface of the bottom wall of the recess-shaped portion of each of the cover members faces a side surface of a corresponding one of the electrodes, and outer surfaces of the side walls of the recess-shaped portion are fusion-bonded to the film body or the film partitioning wall.

2. The laminated battery according to claim 1, wherein the outer surface of the bottom wall of the recess-shaped portion of each of the cover members faces the side surface of the corresponding one of the electrodes.

3. The laminated battery according to claim 2, wherein fusion-bonded portions where the outer surfaces of the side walls of the recess-shaped portion of each of the cover members are fusion-bonded to the film body or the film partitioning wall are folded inward in the recess-shaped portion.
